(19) United States
(12) Patent Application Publication
(10) Pub. No.: US 2015/0262105 A1
(43) Pub. Date: Sep. 17, 2015

(54) WORKFLOW SOFTWARE STRUCTURED AROUND TAXONOMIC THEMES OF REGULATORY ACTIVITY

(71) Applicants: Gilbert Jeffries, Glen Rock, NJ (US); Joanne Claussen, Apple Valley, MN (US); Andrew Neblett, Austin, TX (US)

(72) Inventors: Gilbert Jeffries, Glen Rock, NJ (US); Joanne Claussen, Apple Valley, MN (US); Andrew Neblett, Austin, TX (US)

(73) Assignee: THOMSON REUTERS GLOBAL RESOURCES

(21) Appl. No.: 14/206,648

(22) Filed: Mar. 12, 2014

(51) Int. Cl. G06Q 10/06; G06Q 30/00

(52) U.S. Cl. CPC G06Q 10/06316; G06Q 30/018; G06Q 10/0635

(57) ABSTRACT

The present disclosure is directed towards systems and methods for facilitating regulatory compliance, which comprises receiving a signal related to at least one topic and associating the at least one topic with a predefined theme. The systems and methods of the present disclosure then use the predefined theme to associate the at least one topic with an entity and subsequently associate the at least one predefined theme with a set of predefined workflow tasks. A regulatory workflow routine is created by aligning at least two predefined workflow tasks in an order, said at least two predefined workflow tasks selected from the set of predefined workflow tasks and the regulatory workflow routine is executed by the central server.

### CROSS-REFERENCE TO RELATED APPLICATION

This application claims benefit of U.S. Patent Provisional Application No. 61/777,412, filed Mar. 12, 2013 and entitled “Workflow Software Structured Around Taxonomic Themes of Regulatory Activity,” the contents of which are incorporated herein by reference.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2014 Thomson Reuters.

### TECHNICAL FIELD

This disclosure relates generally towards systems, methods and interfaces for monitoring and facilitating regulatory compliance.

### BACKGROUND

As a result of the recent flurry of the regulatory activity, regulatory compliance thresholds are on the rise for financial services organizations. For example, the recently enacted Dodd-Frank Wall Street Reform and Consumer Protection Act of 2010 has created many significant, complex and far-reaching changes in the financial sector. This increased oversight requires financial organizations to institute effective and comprehensive regulatory compliance and risk programs. Financial organizations must ensure that they can respond quickly and confidently to the information demands of the regulatory authorities. Manual processes for compliance, audit and risk management are themselves too risky and error-prone due to duplicated tasks and efforts across departments, and wasted time searching in multiple repositories for appropriate records.

An organization's compliance department requires access to a wide range of regulatory content in order to assess regulatory and legal requirements, understand industry best practices and create the organization's controls to ensure compliance with the requirements. To ensure that the organization has sufficient controls to effectuate compliance, the compliance professional must possess knowledge of the regulatory requirements in all jurisdictions in which the organization has business operations. Moreover, a process must be created to ensure that all changes to the regulations are reflected in such controls continuously in all jurisdictions. This process can quickly become onerous and cause the organization's controls to become outdated as the process starts to break down.

### SUMMARY

The present disclosure is directed toward a method and a classification system for organizing the regulatory environment by a theme and a design to create workflow solutions that take advantage of this classification system. This method and design incorporate a regulatory theme taxonomy that organizes all the regulatory content—content from regulators as well as the organization's own generated content—into a limited number of “themes” that can be applicable to regulations across many industry sectors. Tracking rules by a regulatory theme allows the organization to have a view of the applicable areas of regulation, independent of an entity's own organizational structure, which may change frequently in response to business and market needs. The themes provide an organization with a consistent view of risks and issues despite boundary changes that can complicate reporting and comparison of risks across time periods.

The method includes receiving a signal related to at least one topic, associating the at least one topic with a predefined theme and using the predefined theme to associate the at least one topic with an entity. According to one embodiment, the method further includes associating the at least one predefined theme with a set of predefined workflow tasks and creating a regulatory workflow routine by aligning at least two predefined workflow tasks in an order, said at least two predefined workflow tasks selected from the set of predefined workflow tasks. A central server then executes the regulatory workflow routine.

By organizing all of the regulations by themes and creating workflow to support the themes, a compliance department can then use the themes as a proxy for the underlying rules. With the combination of a theme, jurisdiction and a business line, the applicable rules can be identified by the present disclosure. Additionally, by using the themes as a proxy for the rules, the method can organize all activities by such themes and organize all resulting data by the themes. For example, the annual risk assessment process can be structured by a theme, each issue in the organization's issue tracking system could be classified by the theme and all audit findings could be tagged by the theme. Once such taxonomy is achieved, the organization, using the present disclosure, can easily create heat map diagrams and other management reports using the themes as an organizing mechanism, effectively converting the noise of compliance management into actionable intelligence.

Additional advantages and/or features of the present disclosure will be set forth in part in the description. It is to be understood that both the foregoing general description and the following detailed description of the present disclosure are exemplary and explanatory and are intended to provide further explanation of the present disclosure as claimed.

### BRIEF DESCRIPTION OF THE DRAWINGS

FIG. 1 is a schematic depicting an exemplary computer-based system for facilitating regulatory compliance;

FIG. 2 is a flow diagram illustrating an exemplary computer-implemented method for facilitating regulatory compliance

FIG. 2A is a diagram illustrating an exemplary workflow routine facilitating regulatory compliance;

FIG. 2B is a diagram illustrating an exemplary workflow routine facilitating regulatory compliance;

FIG. 3 is an example of the themes mapped to a structure of an organization;

FIG. 4 is an example of an impact of a certain rule change on the organization shown by the department;

FIG. 5 is an example of a risk assessment calculation report generated by the computer based system of FIG. 1;

FIG. 6 is an example of a testing and monitoring report generated by the computer based system of FIG. 1; and

FIG. 7 is an example of an enterprise risk and compliance report generated by the computer based system of FIG. 1.

### DETAILED DESCRIPTION

In the following description, reference is made to the accompanying drawings that form a part hereof, and in which is shown by way of illustration specific embodiments in which the disclosure may be practiced. It is to be understood that other embodiments may be utilized and structural changes may be made without departing from the scope of the present disclosure.

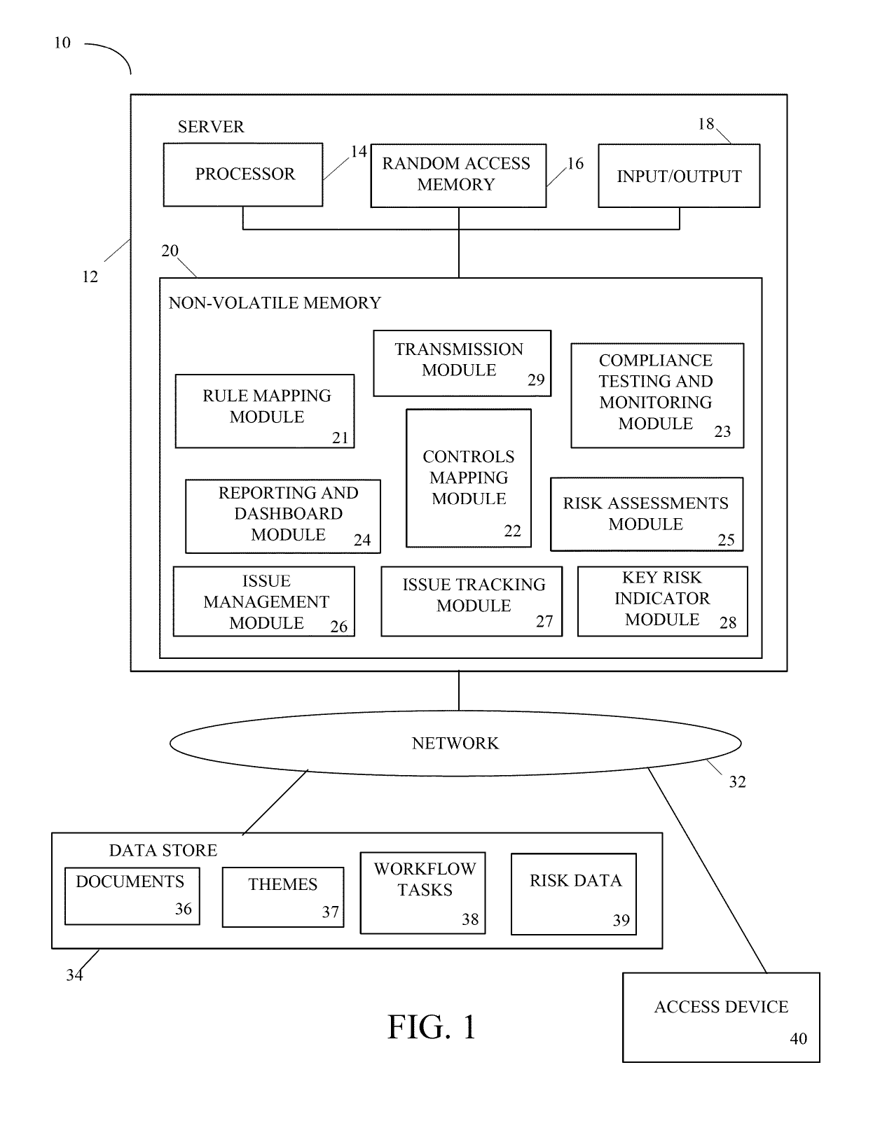

Turning now to FIG. 1, an example of a suitable computing system 10 within which embodiments of the present disclosure may be implemented. The computing system 10 is only one example and is not intended to suggest any limitation as to the scope of use or functionality of the disclosure. Neither should the computing system 10 be interpreted as having any dependency or requirement relating to any one or combination of illustrated components.

For example, the present disclosure is operational with numerous other general purpose or special purpose computing consumer electronics, network PCs, minicomputers, mainframe computers, laptop computers, as well as distributed computing environments that include any of the above systems or devices, and the like.

The disclosure may be described in the general context of computer-executable instructions, such as program modules, being executed by a computer. Generally, program modules include routines, programs, objects, components, data structures, loop code segments and constructs, etc. that perform particular tasks or implement particular data types. The disclosure can be practiced in distributed computing environments where tasks are performed by remote processing devices that are linked through a communications network. In a distributed computing environment, program modules are located in both local and remote computer storage media including memory storage devices. Tasks performed by the programs and modules are described below and with the aid of figures. Those skilled in the art may implement the description and figures as processor executable instructions, which may be written on any form of a computer readable media.

In one embodiment described in the context of a hosted system, with reference to FIG. 1, the system 10 includes a server device 12 configured to include a processor 14, such as a central processing unit (“CPU”), random access memory (“RAM”) 16, one or more input-output devices 18, such as a display device (not shown) and keyboard (not shown), and a non-volatile memory 20, all of which are interconnected via a common bus 19 and controlled by the processor 14.

As shown in the FIG. 1 example, in one embodiment, the non-volatile memory 20 is configured to include a rule mapping module 21, a control mapping module 22, a compliance testing and monitoring module 23, a reporting and dashboard module 24, a risk assessment module 25, an issue management module 26, an issue tracking module 27, a key risk indicator module 28 and transmission module 29. The rule mapping module 21 identifies applicable regulations and associates an organization's business units, identified and tracked in an entities database (not shown) linked to the computing system 10, with rule and/or regulatory themes in order to demonstrate which rules are applicable to the organization's various business units. The control mapping module 22 outlines the themes of policies and procedures that are required for the organization's industry and permits the organization to classify its own policies, procedures, and subordinate topics into these themes.

The compliance testing and monitoring module 23 tracks compliance with implemented controls and determines whether and where additional training, support or controls should be implemented. It is a self-contained audit system for the compliance department and is used to conduct examinations of branch offices and business units to test adherence with applicable compliance policies and procedures.

The reporting and dashboard module 24 utilizes rich tagging of issues and delivered content to provide flexible reporting options on the data consolidated from all of the underlying modules. The risk assessment module 25 is provided for analyzing the organization's industry, jurisdiction and selected themes, and determines recommended areas to survey. The issue management module 26 is used to log all issues that need to be tracked by an organization, while the issue tracking module 27 permits users to tag issues with any of the classification options available, as well as severity grading, due dates, team assignments, and the elements from the business' internal classification systems. The key risk indicator module 28 is configured to suggest key risk indicators for clients based on their industry, business lines, jurisdiction, themes, and the controls they have implemented. Lastly, a transmission module 29 is provided to receive signals associated with one or more topics and to transmit signals associated with workflow routines. Additional details of modules 21 through 29 are discussed further.

As shown in FIG. 1, in one embodiment, a network 32 is provided that may include various devices such as routers, server, and switching elements connected in an Intranet, Extranet or Internet configuration. In one embodiment, the network 32 uses wired communications to transfer information between an access device (not shown), the server device 12, and a data store 34. In another embodiment, the network 32 employs wireless communication protocols to transfer information between the access device, the server device 12, and the data store 34. In yet other embodiments, the network 32 employs a combination of wired and wireless technologies to transfer information between the server device 12, the access device 40 and the data store 34.

The data store 34 is a repository that maintains and stores information utilized by the before-mentioned modules 21 through 29. In one embodiment, the data store 34 is a relational database. In another embodiment, the data store 34 is a directory server, such as a Lightweight Directory Access Protocol (“LDAP”). In yet another embodiment, the data store 34 is an area of non-volatile memory 20 of the server 12.

In one embodiment, as shown in the FIG. 1 example, the data store 34 includes a set of documents 36 that are used to identify a set of topics, such as laws, statutes, regulations or government-issued administrative determinations. As used herein, the words “set” and “sets” refer to anything from a null set to a multiple element set. The set of documents 36 may include, but is not limited to, one or more papers, memos, treatises, news stories, articles, catalogs, organizational and legal documents, research, historical documents, policies and procedures, business documents, and combinations thereof.

The data store 34, according to one embodiment, further includes a set of themes 37, which comprises tables of themes used by the modules 21 through 28 to associate themes with at least one topic. A topic may include laws, statutes, regulations, government-issued administrative determinations, materials from non-government organizations, speeches, announcements, and editorial analyses and summaries of any of the same. Examples of stored themes are entity establishment and governance, capital and accounting, internal controls, risk management, conflicts, employees, sales, trading and research activities, product creation, underwriting and lending activities, recordkeeping, transactional reporting, client assets, third party disputes, data protection, regulatory oversight, and criminal and civil offenses. Each of the above-mentioned themes will be discussed in turn below.

In one embodiment, the data store 34 also includes a set of predefined workflow tasks 38. Examples of the workflow tasks are identifying the entities and businesses, creating users, assigning coverage per business unit, identifying key risk indicators by theme, researching regulations, mapping regulations to all businesses, creating and managing policies and training assessments, inputting metrics, monitoring regulatory change, mapping controls to businesses, performing risk assessments, performing testing and monitoring, planning and scheduling audits, performing audits, managing issues, managing regulator relationship, examining document and inquiries, producing risk dashboards, and producing reports of risks. In one embodiment, the data store 34 also includes a risk data warehouse 39, which stores the data elements from modules 21 through 29 and attaches entitlements based on data visibility level (security) and user role.

According to one embodiment, the access device 40, is a general purpose or special purpose computing device comprising a processor, transient and persistent storage devices, input/output subsystem, bus to provide a communications path between components comprising the general purpose or special purpose computer, and a web-based client application, such as a web browser, which allows a user to access the server 12. Examples of web browsers are known in the art, such as Microsoft® Internet Explorer®, Google Chrome™, Mozilla Firefox® and Apple® Safari®.

Although the data store 34 shown in FIG. 1 is connected to the network 32, it will be appreciated by one skilled in the art that the data store 34 and/or any of the information shown therein, may be distributed across various servers and be accessible to the server 12 over the network 32, be coupled directly to the server 12, or be configured in an area of non-volatile memory 20 of the server 12.

Further, it should be noted that the system 10 shown in FIG. 1 is only one embodiment of the disclosure. Other system embodiments of the disclosure may include additional structures that are not shown, such as secondary storage and additional computational devices. In addition, various other embodiments of the disclosure include fewer structures than those shown in FIG. 1. For example, in one embodiment, the disclosure is implemented on a single computing device in a non-networked standalone configuration. Data input and requests are communicated to the computing device via an input device, such as a keyboard and/or mouse. Data output, such as the computed significance score, of the system is communicated from the computing device to a display device, such as a computer monitor.

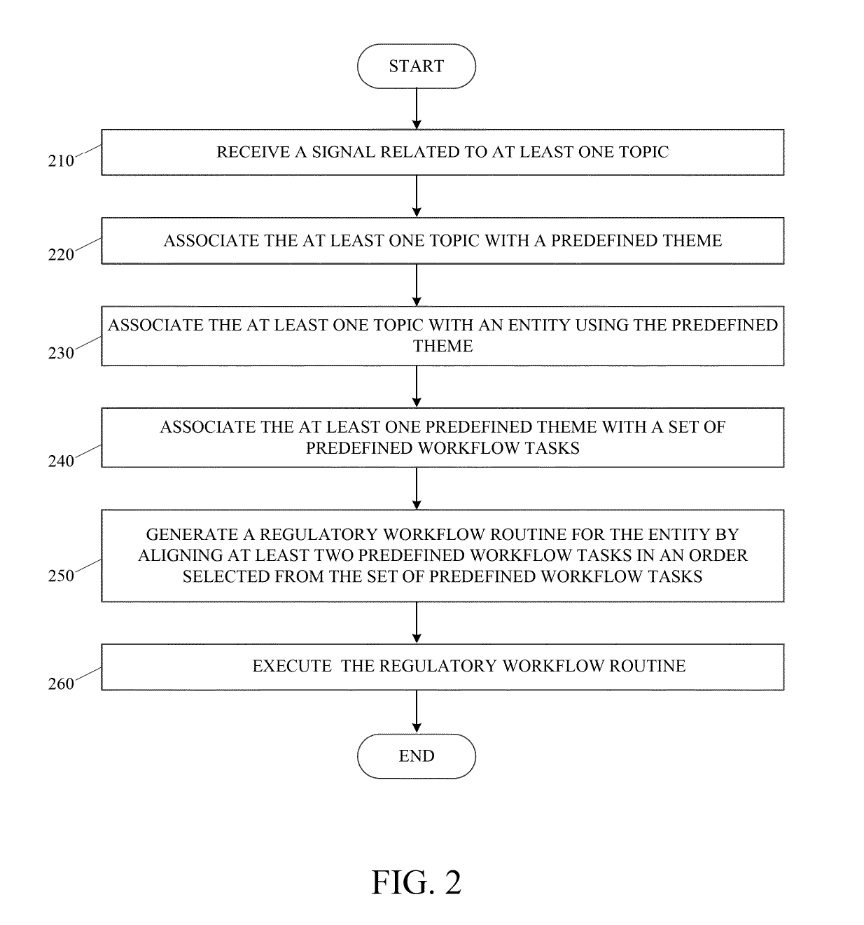

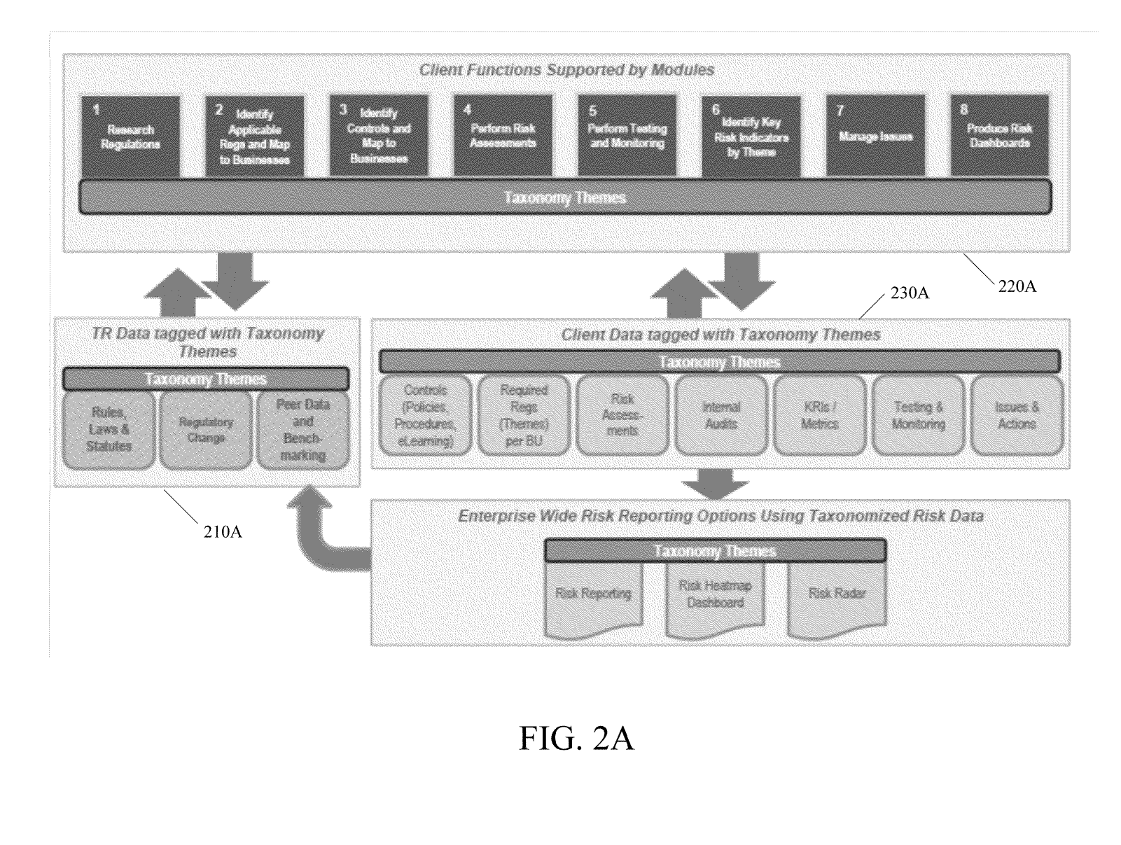

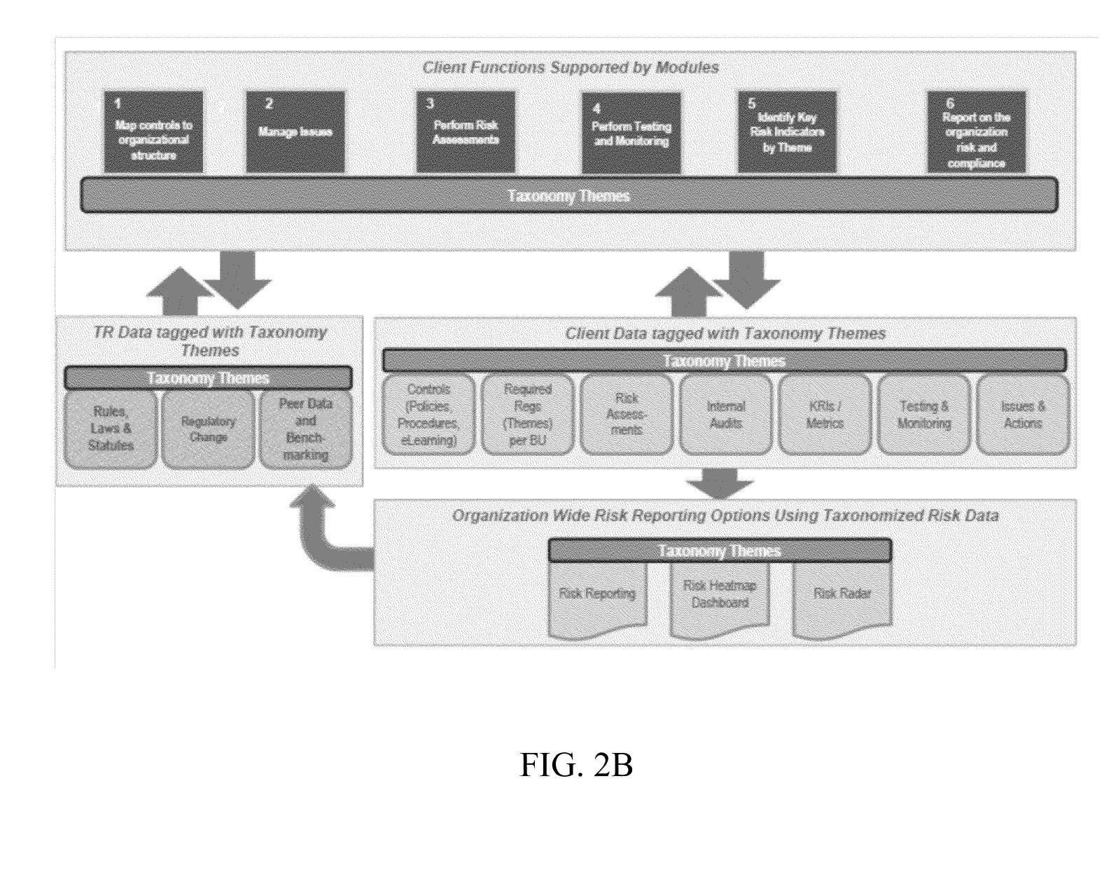

Turning now to FIG. 2, an exemplary method for facilitating regulatory compliance is disclosed. The process of facilitating an organization's regulatory compliance begins with researching various topics and associating the topics with predefined themes. In the illustrated embodiment shown in FIG. 2, the transmission module 29 of the server 12 receives a signal related to at least one topic identified from the set of documents 36, step 210. At step 220, the at least one topic is then associated with a predefined theme in a taxonomic framework. According to one embodiment, a given topic is associated with a predefined theme by the Rule Mapping Module 21 and maintained in the set of themes 37. In another embodiment, a separate automated system, such as Thomson Reuters' ® Categorization and Recommendation Engine (CaRE), is used to classify the topics to a taxonomic framework. The taxonomic framework consists of alphanumeric tags to indicate one or more classification facets, such as subject matter, original issuer, geographic location, applicable jurisdiction, purpose, and regulatory function. Additional facets may be added to the scheme as needed. With the regulatory content organized into a sensible taxonomic framework that allows compliance users to select and distribute content most efficiently, customers can plan for the changing environment, understand the impact of changes and ensure that appropriate mitigation steps are in place. The non-exhaustive list of the pre-defined themes is provided below.

A. Entity Establishment and Governance

The Entity Establishment and Governance theme is associated with topics related to entity authorization such as entity certification, registration, licensing, entity related disclosures, filings, and reporting to regulators. This theme is also associated with topics related to corporate governance such as corporate structure, management of the board, and employment-related compensation, including incentive compensation and compensation of employees of consumer banks Finally, this theme is associated with topics related to insolvency and receivership such as administration of insolvency, bankruptcy, financial contracts, security interests, voluntary arrangements, living wills and winding up a partnership.

B. Capital and Accounting

The Capital and Accounting theme is associated with topics related to capital requirements, which are often referred to as Basel requirements. These include capital requirements for retail banks, insurance companies and broker-dealers. This theme is also associated with topics related to credit rating agencies, securitization, accounting, auditing and tax.

C. Internal Control

The Internal Control Theme is associated with topics related to internal oversight such as compliance reporting, internal topical inspection, compliance risk management, new business and product approvals, periodic review of businesses, compliance surveillance and monitoring, internal audit, and whistle blowing. This theme is also associated with topics related to supervisory processes such as designation of supervisors, communications review, procedures and policies, review and supervision of transactions, supervision of individuals, cross-border activities, transaction and risk control and surveillance, recordkeeping review, technology requirements, physical security, information barriers, and watch and restricted list procedures. Finally, this theme is associated with topics related to third party oversight such as agreements, due diligence, and outsourcing.

D. Risk Management

The Risk Management theme is associated with topics related to management of specific risks such as topics related to market risk, treasury/interest rate/liquidity risk, credit/counterparty risk, operational risk, systemic risk, enterprise risk, Information Technology/system risk and reputational risk. This theme is also associated with topics related to business continuity such as planning and communications.

E. Conflicts

The Conflicts theme is associated with topics related to trading and other business conflicts such as topics related to conflicts management, employee trading, director trading, and outside business activities. This theme is also associated with topics related to affiliates and insiders such as lending to insiders, loans to executive officers, directors and principle shareholders, management official interlocks, and transactions with affiliates.

F. Employees

The Employees theme is associated with topics related to employees and independent producers such as topics related to recruitment, internal transfers, investigation of backgrounds and qualifications, code of conduct policies, registration and licensing, training and continuing education, mandatory absence, disqualifications and disciplinary actions, terminations, and regulatory filings.

G. Sales, Trading and Research Activities

The Sales, Trading and Research Activities theme is associated with topics related to communications and marketing practices such as topics related to advertising and sales literature, oral communications, disclosures, investor education and protection, public appearances, and written communications. This theme is also associated with topics related to research such as research standards, disclosures and statements, and communication chaperoning. Furthermore, this theme is associated with topics related to sales practices such as cold calling and telemarketing, customer capacity/authority, customer suitability, distribution restrictions related to customer category, investment advice, prime brokerage and securities lending sales practices, sharing in customer profits and losses, solicitation, commissions, disclaimers and disclosures, product-specific communications and documentation, community and public policy issues. Finally, this theme is associated with topics related to trading practices standards such as best execution/fair pricing, block positioning errors, market making obligations, order markings, order handling, short selling, third market trading, trading engines/program trading/algorithmic trading, trading halts, payment for order flow, soft dollars and rebates, mark-ups and mark downs, restricted securities and private placements, investment policy, position, monitoring and position restrictions.

H. Product Creation, Underwriting & Lending Activities

The Product Creation, Underwriting and Lending Activities theme is associated with topics related to underwriting practices such as topics related to disclosures, due diligence, organization commitment, government securities, IPOs, lock-up period, municipal securities, offering allocations, secondary market restrictions, pitch books, selling restrictions, price stabilization, syndication activities, capital markets structuring/originations, delegated authority, exposure management, reinsurance, underwriting, underwriting capacity, and risk modeling. This theme is also associated with topics related to insurance underwriting such as underwriting guidelines, valuation, application requirements, and policy conditions. Furthermore, this theme is associated with topics related to credit/lending practices such as due diligence, disclosures, syndication activities, and interest rates. Finally, this theme is associated with topics related to insurance claims such as guidelines, payments, disputes, prohibited acts and forms requirements.

I. Operations and Recordkeeping

The Operations and Recordkeeping theme is associated with topics related to operations such as topics related to valuations, account opening and maintenance documents, bank/custody account maintenance, transfer of accounts exchange fees, comparisons, clearing, settlements and closing of contracts, delivery, receipt and custody of securities, securities lending, debt collection, consumer credit and lending activities, payments, and margin. This theme is also associated with topics related to requirements for specific recordkeeping such as customer account records, employee records, organization financial records, transactional records, communications, reimbursement to financial institutions for providing financial records, and evidence of supervisory compliance.

J. Transactional Reporting

The Transactional Reporting theme is associated with topics related to transactional reporting such as topics related to trade reporting, transaction reporting, audit trail reporting, position reporting/limits, statistics reporting and surveys, and credit transaction reporting.

K. Client Assets

The Client Assets theme is associated with topics related to fiduciary duties such as topics related to client money, client collateral, discretionary accounts, protection/segregation and custody of assets and securities, proxy voting, use of customer assets, investment guidelines, pension and retirement accounts, and trust accounts.

L. Third-Party Disputes

The Third-Party Disputes theme is associated with topics related to dispute resolution such as topics related to customer complaints, litigation and subpoenas, arbitration and dispute procedures, and compensation and restitution.

M. Data Protection

The Data Protection theme is associated with topics related to privacy/information security such as topics related to confidentiality of client, organization and personal information, and standards for safeguarding customer information.

N. Regulatory Oversight

The Regulatory Oversight theme is associated with topics related to regulatory oversight such as topics related to supervision by regulators, regulatory exams and inquiries, hearing and procedures, reporting to regulators, fees, levies and assessments, management certifications, regulatory structure and governance, regulatory filings, and fraud reporting. This theme is also associated with topics related to enforcements such as disciplinary actions, financial penalties, non-financial penalties, third party review, withdrawal or suspension of license or registration, and settlement.

O. Criminal and Civil Offenses

The Criminal and Civil Offenses theme is associated with topics related to insider trading/market abuse such as topics related to fraudulent and misleading conduct, front running/trading ahead of research/trading ahead of client, insider deadline, investigating suspicious trades, market manipulation, and suspicious transaction reporting. This theme is also associated with topics related to anti-money laundering and counter-terrorist financing such as anti-boycott, currency reporting, customer due diligence/know your customer, enhanced due diligence, correspondence accounts, foreign bank, freezing of assets, information sharing, sanctions, shell bank prohibition, suspicious activity reporting, travel rule, politically exposed persons, and specially designated nationals. Finally, this theme is associated with topics related to anti-corruption, general offenses and anti-competitive practices such as bribery, client gifts, political contributions, charitable contributions, collusion, embezzlement, identity theft, misappropriation of funds/securities, unauthorized trading, anti-trust laws, market marker collusion, pricing conventions, tying, unfair or deceptive acts or practices, and claims fraud.

The above-described themes facilitate creation of the link between a business, the topics, and the workflow tasks. Returning to FIG. 2, at step 230, the at least on topic is associated with an entity using the pre-defined theme using the Rule Mapping Module 21. For example, a topic may be assigned to an organizational department within corporation a using the predefined theme associated with a the topic, such as a finance department being assigned the topic of Securities and Exchange Commission regulations using the pre-defined themes of entity establishment and governance, capital and accounting, internal controls. The rule mapping module 21 is used to associate the client's business units, identified and tracked in an entities database linked to the central server 12, with rule and/or regulatory themes in order to demonstrate which rules are applicable to the businesses. At step 240, the at least one predefined theme is a associated with a set of predefined workflow tasks by the rule mapping module 21. In one embodiment, the set of predefined of workflow tasks are maintained in the data store 34 within the database of workflow tasks 38 along with the at least one associated predefined theme. For example, the Sales, Trading and Research Activities theme is associated with the set of workflow tasks including identifying key risk indicators, researching regulations, mapping regulations to all financial business units, creating and manage policies and learning.

A workflow routine is then constructed by the Rule Mapping Module 21 by aligning at least two workflow tasks in an order, the at least two workflow tasks being selected from the set of predefined workflow tasks associated the at least one predefined theme, step 250, which is subsequently executed by the central server 102, step 260. One skilled in the art would be aware of various methods for server execution and signal transmission to a user.

The design of the workflow routine is dependent on the business' characteristics, such as type, structure, size, and location. Examples of workflow tasks are creating users, assigning coverage per business unit, researching regulations, identifying key risk indicators by theme, creating and managing policies and training assessments, inputting metrics, monitoring regulatory change, mapping controls to businesses, performing risk assessments, performing testing and monitoring, planning and scheduling audits, performing audits, managing issues, managing regulator relationship, examining document and inquiries, producing risk dashboards, and producing reports of risks.

An example of a workflow routine is shown in FIG. 2A, which begins by supplying data that has been classified to the themes taxonomy through machine-assisted classification and editorial review, as illustrated in area 210A labeled “TR Data Tagged with Taxonomy Themes.” The machine-assisted classification is described in U.S. Pat. No. 7,065,514, the content of which is incorporated herein by reference.

Referring back to FIG. 2A, according to one embodiment, each of the Function Modules 1 through 8 in the area 220A labeled “Client Functions Supported by Modules” represents a step in the regulatory compliance process to which themes-classified content applies. The themes taxonomy is applied to steps in the workflow routine by means of automated and assisted classification logic as well as editorial suggestion. For example, in Function Module 2, the classification logic suggests themes that apply to each department's compliance responsibilities. This theme-matching directs different regulatory content to different individual users in the organization, according to their function. In Function Module 3, the classification logic connects the risk controls the organization has in place to relevant themes. Risk controls may be classified at a document/event level, or at a more granular level, such as down to the specific question asked in a training assessment.

In Function Modules 4 through 8, the regulatory work flow routine classifies the risk assessments to appropriate regulatory themes, identifies key risk indicators by theme, allows the compliance staff to manage issues according to the regulatory theme, and generates various types of reports according to the themes. Referring back to FIG. 2A, area 230A labeled “Client Data Tagged with Taxonomy Themes” shows the output from the processes in which the organization has engaged, including controls such as policies, procedures and learning assessments, required regulations, risk assessments, internal audits, key risk indicators (KRIs)/metrics, testing and monitoring, issues and actions.

According to one embodiment, the regulatory work flow routine contains three options to facilitate the classification of client data, which are described below, in order of their increasing sophistication, software/implementation footprint, and requirements for access to client data:

(1) The system suggests custom searches that run against commercial content management systems, such as SharePoint, or against shared drives in a networked environment. The searches consist of terms designed to locate content by type as well as topic. The user may modify the searches as needed. This option actually returns content for the user to view. However, the content itself receives no additional metadata unless the customer decides to apply it on their own.

(2) A second option for classification of client data is a metadata creator. In essence this is an assisted content indexing function. For a particular organization structure or type of business (e.g., a financial institution or a healthcare facility), the regulatory work flow routine identifies typically used content types. The regulatory work flow routine then suggests an appropriate set of metadata templates that prompt the user to add metadata in categories such as originating geography, document type, title, subject, responsible department and location information. The metadata may be added at the collection level or document level. If metadata is added at the document level and access to the documents is provided, the system extracts additional information from documents such as the author's name, the date the document was created, and the date it was last edited. The regulatory work flow routine uses a rule-based recommendation scheme to recommend classification themes for the data described in the metadata summaries, the same as described in Functional Module No. 3. These metadata documents may be stored in a central location, separate from the actual content locations.

(3) A third option is an automated themes classifier for customer content. For example, this capability employs a version of the functionality of the West Km® product (described at http://legalsolutions.thomsonreuters.com) that utilizes the regulatory themes taxonomy as its classification scheme. With the West km-powered classification subsystem, the compliance manager is not required to create metadata profiles or manually annotate content. The regulatory work flow routine indexes the documents, keeps the index up-to-date, and suggests regulatory themes classifications to apply to the content.

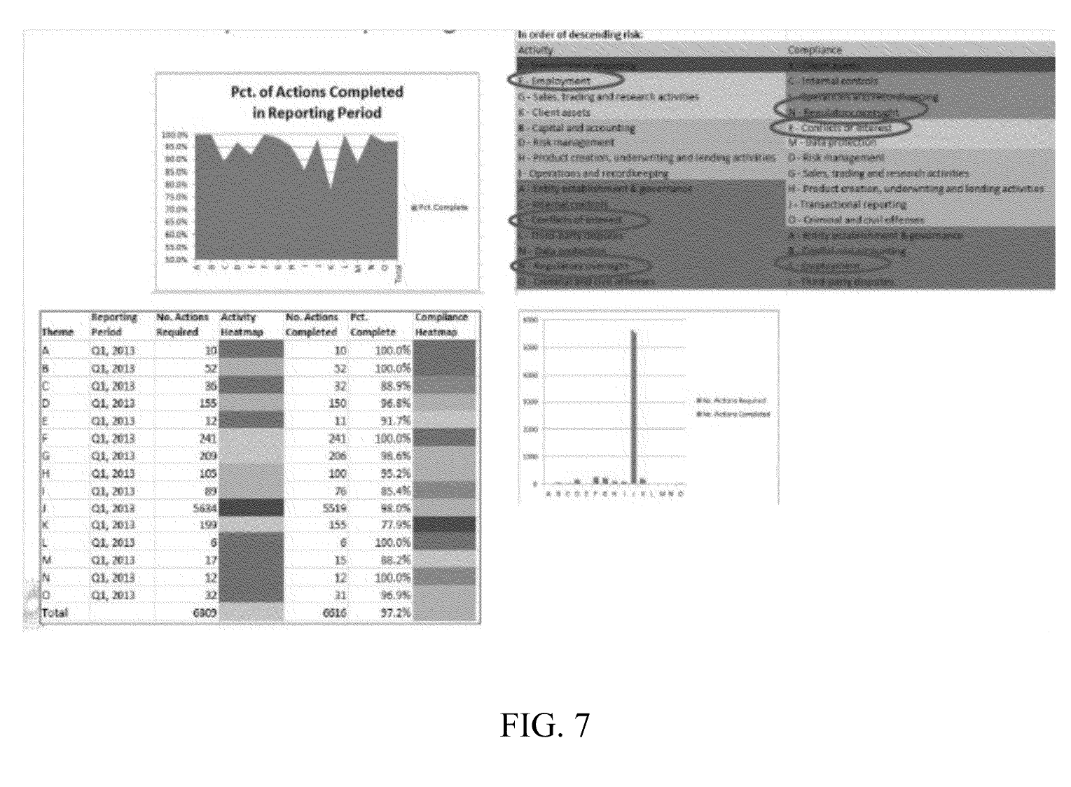

The output from the processes in which the organization has been engaged—the indexed and themes-classified customer data—is rolled up into reports that show risk according to regulatory themes. With all processes, including controls, monitoring, internal audit results, risk assessments, issues, and actions classified according to regulatory themes, the regulatory workflow routine may create consolidated reports in various formats, including activity and risk assessment graphs and “radar” screens, risk dashboards and heat maps. The reports derived from the themes-classified data provide the user with a consistent, ongoing window into the compliance performance of the whole organization. An exemplary report is illustrated in FIG. 7.

In another embodiment, compliance data is collected from the businesses' completion of the workflow routine. The data collected is stored in a database and is used for preparation of metrics, which allow production of more efficient workflow routines.

The following example provides further explanation of the present disclosure and associated modules. This example should not be construed as limiting of the claims in any way.

### EXAMPLE OF A WORKFLOW ROUTINE FOR REGULATORY COMPLIANCE

### Example 1

Financial Industry Regulatory Authority (“FINRA”) Rule change. In the following example, the client, Fictitious Corp., must comply with a change in a rule by FINRA. The changed rule was researched by Thomson Reuters and associated with appropriate themes, as indicated below. After the client selects the industry sector and the geographic area, the client is recommended a regulatory workflow routine comprising multiple work tasks. FIG. 2B illustrates an exemplary regulatory workflow routine comprising six pre-defined workflow tasks, wherein as outlined below, the client is suggested to map controls to organizational structure, perform issue management, perform risk assessments, perform testing and monitoring, identify key risk indicators, and report on the organization risk and compliance

According to one embodiment, a regulatory workflow routine is recommended upon a client selecting an industry and geographic area. For example, compliance professionals at Fictitious Corporation select the industry sector, Financial Industry, and the geographic location, United States of America. Subsequently, a summary document with the following exemplary information is generated and transmitted to Fictitious Corporation through the access device 40 of system 10.
Source: FINRA (Financial Industry Regulatory Authority, successor to NASD)
Jurisdiction: US
Status: Proposed Rule
Issuance Date: Sep. 1, 2013
Effective Date: TBD
Summary of the regulation change: Brokers who switch organizations and receive a signing bonus must disclose that fact to the clients they are planning to bring with them to the new organization.
Purpose of the regulation: Disclose conflict of interest for brokers, who will benefit financially from the move, while their clients may suffer a financial penalty from the move if they are, e.g., required to sell at a loss assets that cannot be moved to the new organization.
Themes assigned: E. Conflicts of Interest; F. Employment; N. Regulatory Oversight.

Task 1: Map Controls to Organization Structure.

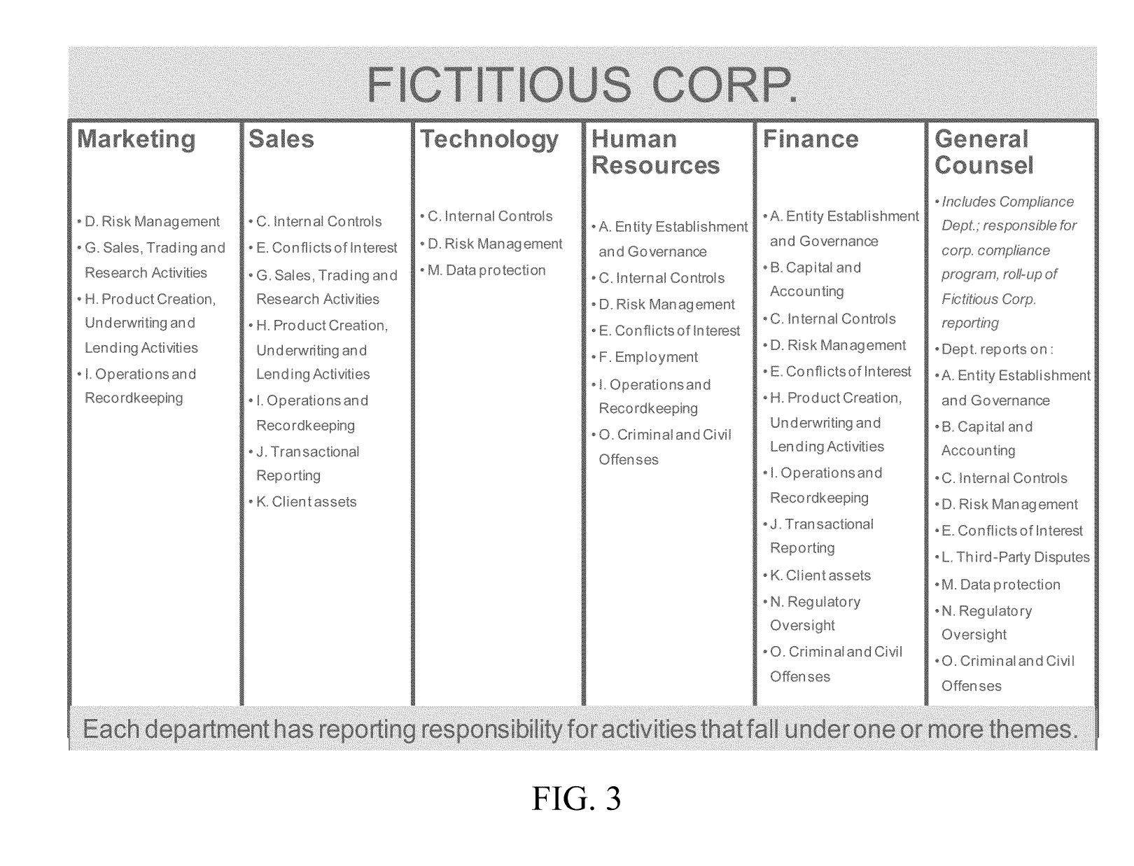

The themes, in one embodiment, are then assigned to organizational departments within the corporation as shown in FIG. 3. For example, the marketing department is assigned themes of risk management, sales, trading and research activities, etc. The sales department is assigned the themes of internal controls, conflicts of interest, etc. The technology department is assigned the themes of internal controls, risk management, and data protection. The human resources department is assigned the themes of entity establishment and governance, internal controls, risk management, etc. The finance department is assigned the themes of entity establishment and governance, capital and accounting, internal controls, etc. Finally, the department of general counsel is assigned the themes of entity establishment and governance, capital and accounting, internal controls, etc.

According to one embodiment, the rule mapping module 21 of system 10 is used to associate the client's business units, identified and tracked in an entities database (not shown) linked to the central server 12, with rule and/or regulatory themes maintained in data store 34 of system 10 in order to demonstrate which rules are applicable to the businesses. In one embodiment, an interface may be employed that allows for the selection of content using one or more of the following attributes to which the content has been classified: (i) regulatory themes or subordinate topics, (ii) type of content, e.g., regulation, legislation, speech, written commentary, (iii) issuing regulator, (iv) date of issuance or effectiveness, (v) geographic location, (vi) legal jurisdiction, e.g., European Union, (vii) industry, (viii) business unit, e.g., Consumer Banking and (ix) business line, e.g., asset-backed securities.

Selected content is delivered immediately and automatically via the network 32 to the person responsible for acting on it at the access device 40. For example, selected content is delivered electronically to a computer station of the compliance professional at the Fictitious Corporation.

The rule mapping module 21 is connected to the controls mapping module 22 of system 10. For every regulatory theme and rule selected, Fictitious Corporation has a control policy active in the system to avoid a gap flagged as an issue in the issue tracking system. Tracking rules by regulatory theme allows the organization to have a view of the applicable areas of regulation, independent of organizational structure, which may change frequently in response to business and market needs. The themes provide an organization with a consistent view of risks and issues despite boundary changes that can complicate reporting and comparison of risks across time periods.

Task 2: Issue Management

In one embodiment, the issue management module 26 of system 10 is used to log all issues that need to be tracked by Fictitious Corp. This issue management module 26 ensures the compliance team is properly addressing and reporting on an organization's risks. As all of the compliance functions can create issues, it is important to have a central issue tracking mechanism to drive action plans with the appropriate teams. According to one embodiment, an issue represents a problem that needs to be resolved and may have one or more action plans, which are items required to address the issue. These action plans should be projects to address or eliminate the noted issue.

According to one embodiment, the issue tracking module 27 permits the tagging of issues with any of the classification options available (e.g., theme, topic, jurisdiction), as well as severity grading, due dates, team assignments, and the elements from the business's internal classification systems. Such tagging of the issues permits highly flexible management of issues and action plans. Each issue has an individual owner (a particular organization employee) and a corporate owner, which could be a department or division in the client's organization structure. An action plan also has an owner, who may be different from the issue owner. For example, a compliance issue may be noted for the Equities division. This issue is to be resolved by a technology department. Therefore, the issue would have an owner in the Equities division, but the action plan is owned by someone in the technology department.

Tagging the issues and action plans by theme allows the organization to track activity, regardless of owner, all the way from notification of a regulation change, through risk assessment, creation or modification of controls, testing, and issue management, without having to rely on manual linking of all activities across the organization that are related to one regulatory change. The resulting reporting is more reliable and builds a more complete picture of the compliance activities throughout the organization.

After a rule change is received, Fictitious Corp's Compliance Department uses the themes classifications to select and assign workflow tasks, also referred to as action items, applicable to this rule change. For example, if the associated theme is “Conflicts of Interest,” then the following actions are assigned to different departments within Fictitious Corporation: (i) General Counsel to (a) draft disclosures to potential clients and (b) oversee compliance department, which coordinates compliance process; (ii) Human Resources to (a) inform potential employee of need to make disclosure, (b) facilitate disclosure by the general counsel and finance departments and (c) modify the human resources policy manual by adding policies related to on-boarding employees from other brokerages; (iii) Sales to instruct the hiring manager to inform potential employee of need to make disclosure and to investigate potential organization conflicts of interest resulting from on-boarding a new client; and (iv) Finance to record amounts of financial compensation in connection with the bonus and provide information to the general counsel department for disclosure. In another example, if the associated theme is “Employment,” then the following actions are assigned to different departments within Fictitious Corporation: (i) Human Resources to (a) inform potential employee of need to make disclosure, (b) facilitate disclosure by general counsel and finance departments and (c) modify the human resources policy manual by adding policies related to on-boarding employees from other brokerages. In yet another example, if the associated theme is “Regulatory Oversight,” then the following actions are assigned to different departments within Fictitious Corporation: (i) General Counsel to draft disclosures to potential clients and oversee compliance department, which coordinates compliance process; and (ii) Finance to record the amounts of financial compensation in connection with the bonus and provide information to the general counsel department for disclosure.

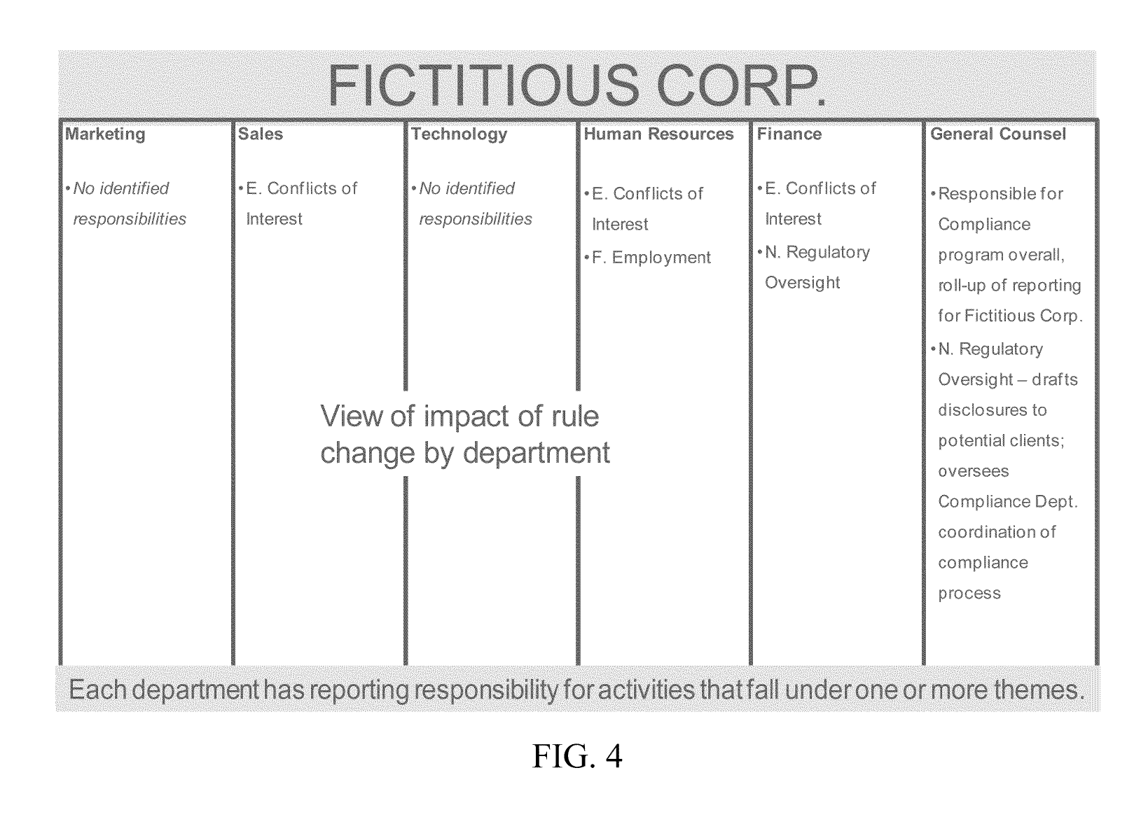

An exemplary impact of the rule change on the corporation by department is shown in FIG. 4. As shown in this figure, the FINRA rule change did not affect the responsibilities of the Marketing and the Technology departments. The Sales, the Human Resources, the Finance, and the General Counsel departments are impacted by the change in the FINRA rule and are required to take a certain action.

Task 3: Perform Risk Assessments.

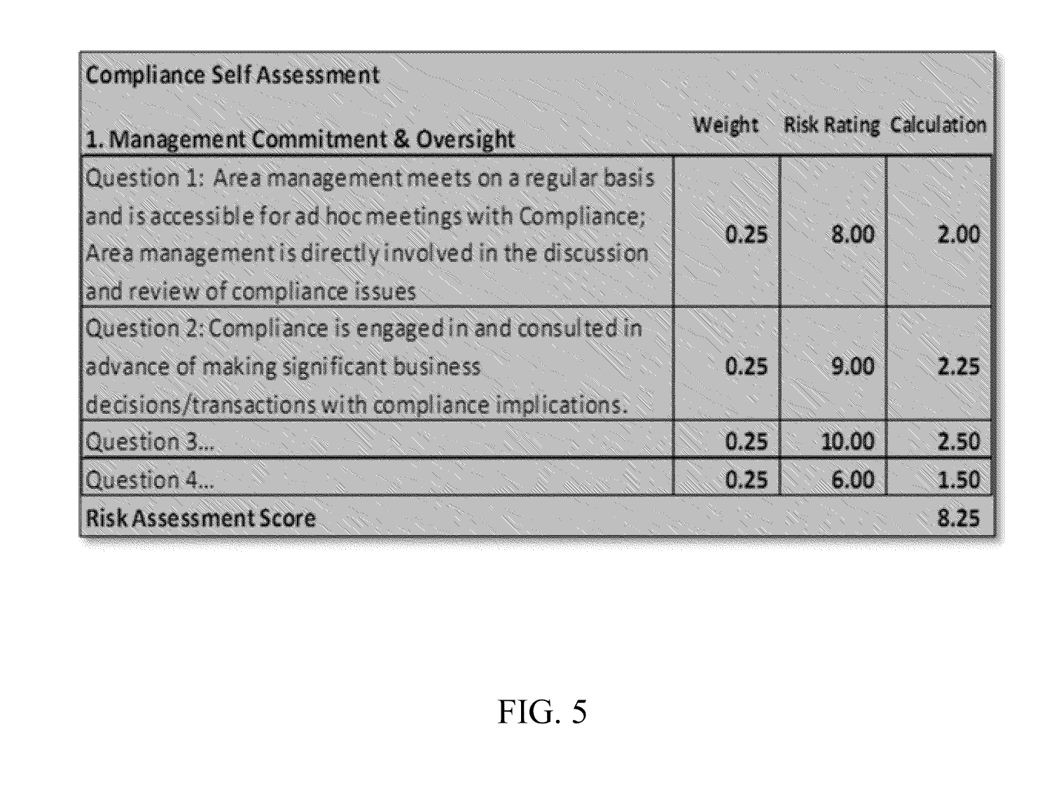

According to one embodiment, Fictitious Corporation then incorporates the new rule into existing risk assessments for the identified themes: (i) Conflicts of Interest; (ii) Employment; (iii) Regulatory Oversight. An example of a risk assessment calculation report is shown in FIG. 5.

In one embodiment, a compliance department of Fictitious Corporation assesses the regulatory risk facing each business unit by conducting a formal risk assessment. This process assigns a risk rating for the inherent risk of each business, a control risk rating and then a net residual risk rating that indicates the relative risk remaining The risk assessments module 25 of system 10 analyzes the organization's industry, jurisdiction and selected themes, and determines recommended areas to survey, such as management commitment and oversight, infrastructure effectiveness, culture of ethics and accountability, policy and procedures, training and professional competency, compliance risk, compliance issues and reporting and communication.

According to one embodiment, the assessment is created by defining the questions, assigning each question a theme from the regulatory themes taxonomy, defining rating values, setting the weight for each question and determining the response categories for the surveys based on total scores. Key themes, such as themes that carry more risks to an organization, could be assigned a higher weight or point value so responses associated with the key themes have more impact on the rating.

Based on the inputs from the assessment and the business units identified in the organization, the regulatory workflow routine creates a survey for each of the business units and alerts its compliance coverage team. Once the survey results are tabulated, each line item is given a score or value. As shown in FIG. 5, according to one embodiment, the scores are aggregated in order to determine an overall rating. According to another embodiment, the overall rating is determined by taking the average of the individual scores for the line items. The qualitative values associated with the numeric rating are determined according to a scale, which is assigned when creating the survey. For example, certain numeric values may correspond to a scale of “Strong”, “Satisfactory”, or “Needs Improvement.” According to one embodiment, the values for Weight and Risk Rating may also be selected by the risk assessment manager. In another embodiment, the regulatory workflow routine will have templates with suggested values, utilizing customer feedback. Some customers may use their own severity ranking systems, and the system will provide the ability for customers to input their own values.

The risk assessments module 25 uses normative standards derived from the peer data resident in an aggregated collection of companies' own quarterly and annual risk assessment surveys that are also tagged by the areas mentioned above, as well as by regulatory theme. A compliance user consults the risk ratings from the standards for their industry, business segment and regulatory theme to determine risks that should be minimized by additional controls. The factors for selecting risks that need to be minimized could include cost of implementing, likelihood of risk, and risk appetite of the organization, among others.

Based on the residual risk rating from the risk assessment, the risk assessments module 25 forwards testing and monitoring schedule suggestions to the compliance testing and monitoring module 23 as to which business units, themes and/or jurisdictions need to be examined based on the assessment ratings. The suggestions are tagged by the regulatory theme as well as by the department and the responsible party to aid in tracking. For example, the suggestions inform the testing group of areas of high risk and/or weak controls that need to be tested in more detail, and suggest increased frequency for the testing and monitoring.

Task 4: Perform Testing and Monitoring.

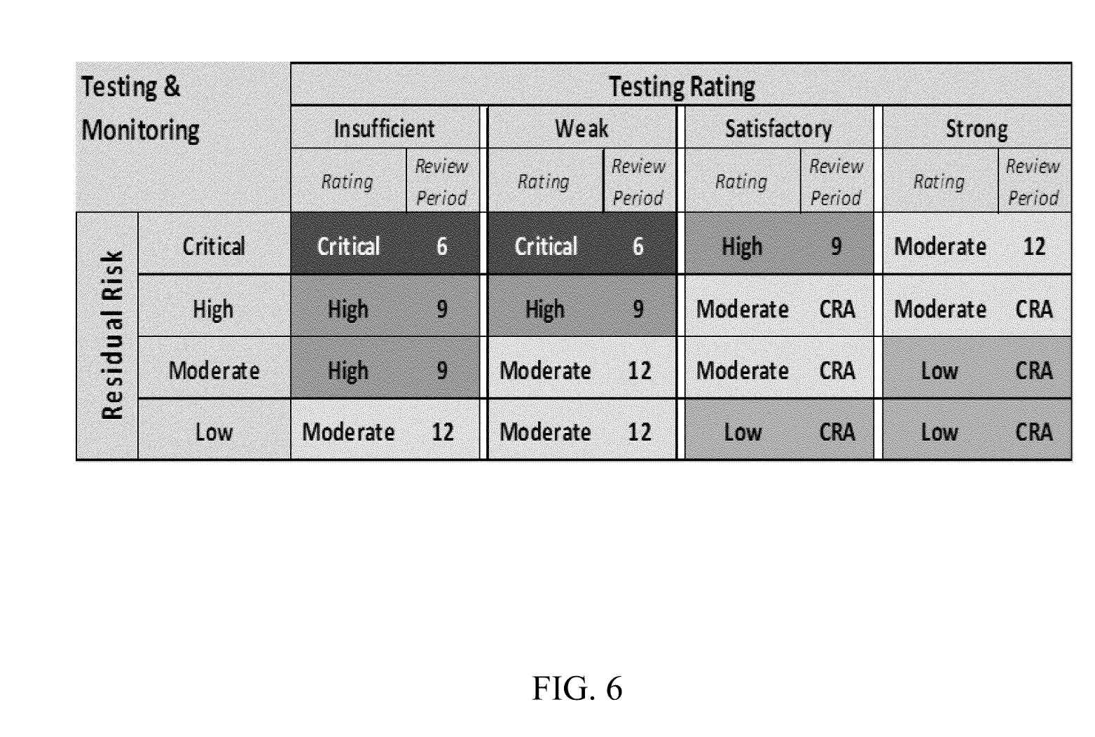

In one embodiment, Fictitious Corporation performs testing and monitoring of controls in place for the identified themes. An example of the testing and monitoring report is shown in FIG. 6. Compliance users must continuously monitor and test controls that are in place to ensure the controls are adequate and are followed by the staff. The risk assessment process with regard to Task 4 described above informs the monitoring and testing group where to focus their efforts by highlighting high-risk businesses and/or functions. In one embodiment, the compliance testing and monitoring module 23 is used to track compliance with implemented controls and determines whether and where additional training, support or controls should be implemented. For example, the compliance testing and monitoring module 23 is used to conduct examinations of branch offices and business units to test adherence with applicable compliance policies and procedures. The testing function is similar to an internal audit. The test is centered on a theme or area of regulation and/or a specific business unit or function, or a combination of the two.

The compliance testing and monitoring module 23 includes a matrix with input values created by the client that defines the next review period for each combination of residual risk rating and testing rating from this module. The testing matrix incorporates the testing and monitoring suggestions forwarded from the risk assessment module. The output of this matrix is the next review period that is mandated by the system.

For example, if the initial annual risk assessment for the theme of Communications and Marketing Practices produced a residual rating of “High” because of missing or outdated policies and procedures, the compliance testing and monitoring group would be informed to conduct a test of the marketing department policies and procedures. If the result of this test turned out to be satisfactory because the unit created policies and procedures after the risk assessment, then the system marks the Communications and Marketing Practices theme for that group as “complete,” and does not require a follow-up. However, if the issues were not fully resolved, a compliance professional could provide a rating of “Weak” or “Insufficient” and force a follow-up exam in a shorter period of time.

Task 5: Identify Key Risk Indicators by Theme.

In one embodiment, the compliance department at Fictitious Corporation may also monitor certain formulas or metrics that may indicate emerging risks to the organization. These key risk indicators (“KRIs”) could be as simple as reduced compliance coverage for a given business unit or an increase in filings related to anti-money laundering. These KRI alerts may influence the other processes such as risk assessments or testing.

The key risk indicator module 28 suggests KRIs for clients based on their industry, business lines, jurisdiction, themes, and the controls they have implemented. The key risk indicator module 28 also allows for the definition of parameters that should be tracked per business unit that may indicate an increasing level of risk for the business and provides periodic alerts to a compliance coverage department in order to provide the opportunity to enter metrics associated with the KRIs. The key risk indicator module 28 uses the metrics to determine whether an alert should be generated. For example, in an environment in which the number of active customers is growing at a rate greater than 10% annually, the user in a retail banking group enters a metric of no more than a 10% increase in customer complaints of information privacy violations in a year. If customer complaints of privacy violations increase by 20%, the key risk indicator module 28 flags the metric, creates an issue, and forwards it to the issue tracking module 27 for investigation.

The KRIs are organized by taxonomy theme for reporting purposes. In the information privacy example above, the KRI could be associated with the data protection theme as it is related to the topic of confidentiality of client information. The resulting KRIs could then be tracked across business units to facilitate analysis and comparison of related KRIs across the organization.

The testing and monitoring procedures vary widely in the industry and are well known in the art. One with an ordinary skill in the art would be able to design and implement testing and monitoring procedures congruent with their company's policies.

Task 6: Reporting on the Enterprise Risk and Compliance.

One of the functions of the compliance department is to report the key issues and risks facing the organization to executive management and the Board of Directors. These key issues and risks may arise from emerging regulations, risk assessment and/or testing results, or alerts from KRIs. According to one embodiment, the reporting & dashboard module 24 utilizes the rich tagging of issues and delivered content to provide flexible reporting options on the consolidated data from all of the underlying modules within the user's entitlements and subscriptions. The risk data warehouse 39 stores the data elements from all of the modules and attaches entitlements based on data visibility level (security) and user role. A user interface attached to the risk data warehouse, and accessible by access device 40, allows a user to select the report or dashboard format, the entity, business unit, jurisdiction, theme, and role (business, compliance coverage, management, executive, etc.). The reports may be organized by a theme, legal entity, business unit, jurisdiction, regulator, or in order of risk by dollar value or other metric. An exemplary report is illustrated in FIG. 7. Adding a regulatory themes classification to the standard reporting elements facilitates the creation of flexible, meaningful, actionable reports that automatically roll up risks and compliance activities throughout the organization.

In one embodiment, the reporting & dashboard module 24 generates a heat map dashboard of risks by theme, wherein the graphical representation of data for individual values for a legal entity, business unit, jurisdiction or any combination thereof is represented by color. This module provides the ability to create a customized consolidated risk dashboard for certain roles such as management and executive roles. This executive risk dashboard offers options such as graphically indicating where in the organization the riskier businesses are, or which regulatory theme has the most risk.

In addition to the organization's own data, the reporting & dashboard module 24 makes use of peer data derived from a repository of shared customer reports of risk and compliance data, and reports and analysis by industry experts. To prompt broader sharing of risks, issues and controls, information in peer reports identifying specific entities is removed and the data rolled up into reporting groups by industry and jurisdiction. Data from at least three reporting entities per industry and jurisdiction is required to establish a peer group for comparison purposes. Any of the reporting and dashboard elements may be selected for peers to create a benchmark of risks and compliance activity against which the organization may compare itself—by theme, jurisdiction, regulator and so forth.

The reporting procedures vary widely in the industry and are well known in the art. One skilled in the art would be able to design and implement reporting procedures congruent with their company's policies.

FIGS. 1 through 7 are conceptual illustrations allowing for an explanation of the present disclosure. It should be understood that various aspects of the embodiments of the present disclosure may be implemented in hardware, firmware, software, or combinations thereof. In such embodiments, the various components and/or steps may be implemented in hardware, firmware, and/or software to perform the functions of the present disclosure. That is, the same piece of hardware, firmware, or module of software may perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the disclosure as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present disclosure to a single embodiment, as other embodiments are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific embodiments so fully reveals the general nature of the disclosure that others can, by applying knowledge within the skill of the relevant art(s) (including the contents of the documents cited and incorporated by reference herein), readily modify and/or adapt for various applications such specific embodiments, without undue experimentation, without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present disclosure have been described above, it should be understood that they have been presented by way of example, and not limitations. It would be apparent to one skilled in the relevant art(s) that various changes in form and detail could be made therein without departing from the spirit and scope of the disclosure. Thus, the present disclosure should not be limited by any of the above-described exemplary embodiments, but should be defined only in accordance with the following claims and their equivalents.

What is claimed is:

1. A computer-implemented method for facilitating regulatory compliance in a computer-based system having a central server executing regulatory workflow routines and being in communication with a database for storing regulatory compliance related data, the method comprising:
receiving a signal related to at least one topic;
associating the at least one topic with a predefined theme;
using the predefined theme to associate the at least one topic with an entity;
associating the at least one predefined theme with a set of predefined workflow tasks;
creating a regulatory workflow routine by aligning at least two predefined workflow tasks in an order, said at least two predefined workflow tasks selected from the set of predefined workflow tasks; and
executing, by the central server, the regulatory workflow routine.

2. The computer-implemented method of claim 1, further comprising:
collecting compliance data generated by the regulatory workflow routine; and
producing a report comprising categorized data generated by the regulatory workflow routine.

3. The computer-implemented method of claim 1, wherein the predefined theme is one of entity establishment and governance, capital and accounting, internal controls, risk management, conflicts, employees, sales, trading and research activities, product creation, underwriting and lending activities, recordkeeping, transactional reporting, client assets, third party disputes, data protection, regulatory oversight, and criminal and civil offenses.

4. The computer-implemented method of claim 1, wherein the at least two predefined workflow tasks are one of creating users, assigning coverage per business unit, identifying key risk indicators by theme, creating and managing policies and training assessments, inputting metrics, monitoring regulatory change, mapping controls to organization structure, performing risk assessments, performing testing and monitoring, planning and scheduling audits, performing audits, managing issues, managing regulator relationship, examining document and inquiries, producing risk dashboards, and producing reports of risks.

5. A system for facilitating regulatory compliance comprising:
at least one access device, the at least one access device comprising a processor;
a memory coupled to the processor; and
c. a set of computer readable internet restriction program instructions executable by at least one of the memory and the processor, the set of computer readable internet restriction program instructions configured to:
receive a signal related to at least one topic;
associate the at least one topic with a predefined theme;
using the predefined theme to associate the at least one topic with an entity;
associate the at least one predefined theme with a set of predefined workflow tasks;
create a regulatory workflow routine by aligning at least two predefined workflow tasks in a order, said at least two predefined workflow tasks selected from the set of predefined workflow tasks;
create a regulatory workflow routine by aligning at least two predefined workflow tasks in a desired order, said at least two predefined workflow tasks selected from the set of predefined workflow tasks; and
execute by the central server a regulatory workflow routine.

6. The system of claim 5, further configured to:
collect compliance data generated by the regulatory workflow routine; and
produce a report comprising categorized data generated by the regulatory workflow routine.

7. The system of claim 5, wherein the predefined theme is one of entity establishment and governance, capital and accounting, internal controls, risk management, conflicts, employees, sales, trading and research activities, product creation, underwriting and lending activities, recordkeeping, transactional reporting, client assets, third party disputes, data protection, regulatory oversight, and criminal and civil offenses.

8. The system of claim 5, wherein the at least two predefined workflow tasks are one of creating users, assigning coverage per business unit, identifying key risk indicators by theme, creating and managing policies and training assessments, inputting metrics, monitoring regulatory change, mapping controls to organization structure, performing risk assessments, performing testing and monitoring, planning and scheduling audits, performing audits, managing issues, managing regulator relationship, examining document and inquiries, producing risk dashboards, and producing reports of risks.

9. Non-transitory computer readable media comprising program code stored thereon for execution by a programmable processor to perform a method for facilitating regulatory compliance, the computer readable media comprising:
program code for receiving a signal related to at least one topic;
program code for associating the at least one topic with a predefined theme;
program code for using the predefined theme to associate the at least one topic with an entity;
program code for associating the at least one predefined theme with a set of predefined workflow tasks;
program code for creating a regulatory workflow routine by aligning at least two predefined workflow tasks in an order, said at least two predefined workflow tasks selected from the set of predefined workflow tasks; and
program code for executing by the central server the regulatory workflow routine.

10. The computer readable media of claim 9, further comprising:
program code for collecting compliance data generated by the regulatory workflow routine; and
program code for producing a report comprising categorized data generated by the regulatory workflow routine.

11. The computer readable media of claim 9, wherein the predefined theme is one of entity establishment and governance, capital and accounting, internal controls, risk management, conflicts, employees, sales, trading and research activities, product creation, underwriting and lending activities, recordkeeping, transactional reporting, client assets, third party disputes, data protection, regulatory oversight, and criminal and civil offenses.

12. The computer readable media of claim 9, wherein the at least two predefined workflow tasks are one of creating users, assigning coverage per business unit, identifying key risk indicators by theme, creating and managing policies and training assessments, inputting metrics, monitoring regulatory change, mapping controls to organization structure, performing risk assessments, performing testing and monitoring, planning and scheduling audits, performing audits, managing issues, managing regulator relationship, examining document and inquiries, producing risk dashboards, and producing reports of risks.
